(19) United States
(12) Patent Application Publication
(10) Pub. No.: US 2017/0109834 A1
(43) Pub. Date: Apr. 20, 2017

(54) IMPROVED SYSTEM AND METHOD FOR MANAGEMENT OF PROFESSIONALS

(71) Applicants: Ahmed Farouk SHAABAN, Chicago, IL (US); Venkat THANDRA, Chicago, IL (US)

(72) Inventors: AHMED FAROUK SHAABAN, SOUTH BARRINGTON, IL (US); VENKAT THANDRA, CHICAGO, IL (US)

(21) Appl. No.: 14/894,189

(22) PCT Filed: Aug. 17, 2015
(86) PCT No.: PCT/US15/45586

§ 371 Date: Jan. 12, 2016

Related U.S. Application Data
(60) Provisional application No. 61/998,577, filed on Jun. 30, 2014.

(51) Int. Cl. G06Q 40/00

(52) U.S. Cl. CPC G06Q 40/125

(57) ABSTRACT

The present invention consists of an improved System and Method for managing and operating a company on a global basis wherein company data, income, costs and expenditures may be assigned down to the level of Practice Group, Sub Practice Group, a Timekeeper or Local Profit Center. In lieu of managing a company by the top down from a main parent Global Corporation, an International company is managed horizontally by grouping workers into categories, and then managing those workers across Local Worker Groups, then Regional and then National. In such a manner, the company may run reports to show optimal profitability and management of workers.

### PRIORITY CLAIM

The present application herewith claims priority of Provisional App. No. 61/998,577, which was filed Jun. 30, 2014, and shall be considered as if fully set forth herein.

### FIELD OF THE INVENTION

The present invention relates to the automation of handling an Organizational Structure for large Companies and Firms by encoding critical data such that it is more versatile in use and vastly improves reporting techniques for optimal management performance.

### BACKGROUND OF THE INVENTION

In the current marketplace, there are a variety of computerized time and billing systems for professional firms which are marketed under the following Trademarks: Timeslips by Sage, BillQuick, Clio and others. Some of these systems are computer based while others operate primarily in a cloud computing environment. These systems, however, are not suited to large law firms and professional firms having a global presence, with multiple offices in a plurality of countries which must be linked together for proper billing and financial management. In addition, these are basic programs which do not contain the most up to date features such as transmissions by text, email, fax, computer voice calling, and social media announcements and billing. Other numerous and varied disclosures related to billing and timekeeping are also disclosed in the prior art as shown below. These programs do not allow a Global Corporate Parent to manage a plurality of international related corporations wherein through improved coding of key criteria or financial groups, it is possible to manage and roll up financing without keeping a wide variety of dedicated individual related corporation ledgers and subledgers. In addition, the prior art programs do not have the encoding in place to transfer and utilize data seamlessly between accounting, billing, finance, inventory, human resources and other departments which collect and report on a wide range of data. Further, the prior art systems cannot seamlessly roll up and roll across company data from related companies which have need for the data, even at the most minute, granular level.

EP 1,145,162 issued to Ashby discloses the use of a System for processing credit applications, financial and insurance services and administrative and management tools. The System will generate a price quote for insurance and finance and facilitate on line credit application processing. It will further provide detailed reports for finance, insurance inventory, tracking and other administrative matters. It will provide quick quotes for a lease or loan. It will also perform: inventory tracking, insurance tracking, purchase tracking, applicant profiling, targeted marketing, customer satisfaction, etc. The system will collect data for credit, a description of the item being sold, insurance will be offered for the item, licensing and data required for the government will be collected.

Ashby also discloses that the User can be a financial institution, a dealer, manufacturer, insurer or supplier. It can utilize and store credit agreements with customer ratings and interest rates which can be bundled and sold on a public exchange. FAQ's can be provided in the system, and it can provide Quick Quotes on the spot to the consumer. However, this disclosure is directed to car sales and insurance, not timekeeping. The terms it stores are contract terms, contract ID, customer ID, buy rate, the sales rate, dealer markup, payments, cash down, trade in value, lease fee, monthly payments, commission and taxes due. However, Ashby does not relate to professional timekeeping or billing.

EP Patent No. 1,769,452 issued to Allin discloses the use of a computerized system for residential and commercial construction projects to maintain and disburse construction draws during construction. It can track lien waivers, and can prepare, approve, sign and distribute hundreds of checks to subcontractors each month. It also tracks construction change orders. It can manage all of the persons involved in each draw. It manages and generates a construction budget and time line. It also manages payments to material suppliers. It can manage and store the inspection data for each project. It can manage budgets for GC's as well as the subs. It handles ACH payments. Template forms are utilized to facilitate the draw process. Notices can be sent by email, text or voice.

EP Patent No. 2,026,222 issued to Alquier discloses the use of a system and method which allows the addition, modification and deletion of data base fields dynamically without the use of a data base administrator. The system allows the addition and modification of an informational structure dynamically distributed directly via the user interface. It supports different types of entity attributes including, text, numerical information, date ad time, predefined values and binary objects, allows the creation of relational dependancies between information entities (e.g., patent/child), provides flexible reporting capabilities including spreadsheets, slides, documents, timelines, etc.; it allows a configurable data entry interface; it allows importation of data from external sources; it allows full text searches; logs modifications for an audit trial (important for pharma and med devices); includes email notifications. It allows for a user interface that is flexible and configurable. The system uses template items, coding and tables to accomplish these purposes. However, it is not directed toward time tracking and billing generation.

U.S. Patent Disclosure No. 2003/0120538 filed by Boerke, et al. discloses the use of a method for tracking progress on a task by dividing the period of time into a plurality of timeslots and determining a target number of subtasks to be completed during each timeslot. For example, the time slots may be divided into 15 minute increments. The system only tracks the number of subtasks completed for each timeslot. The method also keeps track statistically of variances in subtasks completed between workers. The task may include any type of work. The process may be used for planning purposes, i.e., as a planning tool such that management can plan and process daily or monthly work shifts according to the work to be done for particular tasks and subtasks. This helps a supervisor spot and correct negative variances in worker performance. The progress can be logged into a computer or worksheet or in paper format. Problems are also noted by the method for correction to improve performance by variance cards.

U.S. Patent Disclosure No. 2013/00090968 filed by Borza, discloses the use of an employee management and scheduling method which is directed to ensure that adequate personnel are present as required and that statutory requirements are met and costs are tracked and minimized. The Borza disclosure is also directed at apps for management cell phone usage wherein managers can track employees, their shifts and their skills and managing same. This allows for real time changes by employees that are sick or have not shown up for work. The locations may also be tracked. Scheduling software is used to manage multiple employees at multiple locations. From one screen, a manager may create, edit and delete shifts and also have access to other aspects of managing the organization staffings with information about positions, teams, skills, etc. being provided. The System can print Shift Assignment Reports and Employee Reports. However, this disclosure is directed toward scheduling employees and not tracking their time or billing for their time.

U.S. Patent Disclosure No. 2012/0233044 filed by Burger, et al., discloses the use of a Method and System for labor project management and costing which may run on a cell phone app to monitor employee activity, identify faulty activity and manage allocation of labor resources. The app, as installed on an employee cellphone, allows the employee to travel to various job locations and record the activities at each job location. The employee may log into or out of the timeclock app installed on the employee's cellphone. The system can be used to monitor managers and administrators as well as employees. The system can be used to transmit payroll information. A flag may be generated if the worker travels outside the permissible areas allocated to his role. The system stores employee photos, job locations, routes, job codes, SIC codes, etc. may be entered into the back end by an administrator. The system also generates reports, and has a “Dashboard” or summary report simply show who is on the jobe, what time they arrived and GPS confirmation of location. The LPM platform may also be operated in the Cloud.

U.S. Patent Disclosure No. 2014/0258057 filed by Chen discloses the use of a system and method for tracking the User's time of a mobile device for the purpose of billing clients. The system is provided with a digital timer which is launched at the time of arrival and then stopped when the employee leaves. The system is directed at tracking time on a mobile device or app. It tracks time sending texts and emails. Time is recorded as soon as the professional receives a voice mail, phone call, text or email. The user can also input notes with the system's time recording and entry. The app automatically looks up in the user's contacts list whether the call or email or text coming in is from a client, and if so, it begins to track it for billing purposes. If not in the contacts registry, the user is alerted at the time and can add the contact as a client to be billed.

U.S. Patent Disclosure No. 2013/0290154 filed by Cherry, et al. discloses the use of the system and method to manage employees at a plurality of jobsites by providing a database wherein a set of job site data is stored therein. Employee devices may collect a set of time punch data and photos to store in the system. Management apps are used on supervisory devices to monitor the job site data and employees and validate photos and activate employee apps. This system is shown operating on a Cloud environment. The app will operate with a web browser, WiFi or on GPS authentication. The system essentially operates as a time tracking system for job sites. The system stores time photos of the employees at check in and check out. The system also records a job number, a job phase and a cost code. The system also has a payroll calculator communicating with a payroll service.

U.S. Patent Disclosure No. 2001/0042032 filed by Chrawshaw discloses the use of a system for capturing, processing and reporting time and expense data which can include flat fee billing, maximum fee billing and will also allow for discounts and write offs. It can be used for a wide range of businesses. A client will not have access to internal data of the company. The system will produce bills, expense reports, time sheets, proposals and project tracking. This appears to be a conventional program for law firm data which is run on a local server for one location. The system may produce various reports as needed. Bills may be delivered by email. The program will create envelopes for the bills. The system will also create budgets for the client.

U.S. Pat. No. 6,038,547 issued to Casto discloses the use of a construction tracking and payment system for use by contractors and subcontractors so that work may be tracked and payment may be timely made after the work is completed and inspections performed. The system complies with AIA requirements. The system may be implemented on a handheld computer. The system will break down a construction job into various elements, and then a contractor or subcontractor will be given a copy of how the site is partitioned, then each contractor or sub is responsible for submitting applications using the partitioning to ensure uniformity the architect desires to impose. The system can import and use CAD information on the job site. The system uses coding approved by the AIA.

U.S. Pat. No. 6,747,679 issued to Finch, II, et al. discloses the use of a time keeping and expense tracking server including a server that implements computer instructions that define logic for building GUI screens according to user instructions. The user can implement and design the screens needed for the tasks of time keeping and expense tracking. The system may be implemented on the Cloud or Internet with a laptop or wireless device desired. The GUI screen may be customized on a copany by company basis, a department by department basis, etc. The system also includes security wherein projects and project codes are only viewable by certain level employees.

U.S. Pat. No. 7,343,316 issued to Goto, et al. discloses the use of a network based shift scheduling system for generating temporary shift workers. It is sent over portable terminals over a network. The system is set to secure and provide work for a plurality of workers. Workers can also submit cancellations or shift changes via the system. The system also accommodates email for communication purposes. The system may also recruit new employees. The system stores the name, age, sex address, mail address and qualifications of the employee, the workable time slots, the type of job, hourly wage, etc.

WPO 2014/016796 filed by Gupta, et al. discloses the use of a system and method for employee tracking in a mobile communication device wherein dynamic location reports may be generated in real time or near real time. The system is directed to door to door delivery or pickup sales forces. The System uses a mobile app on the employees cellphone to conduct the tracking of the employee. The system will raise flags if deviations from tracking occur. The system uses Blue Dophil software to analyze where employees should be performing tasks and produces flags when paramaters gathered fall outside permissible ranges. These flags are sent to management via text or email.

U.S. Pat. No. 6,832,176 issued to Hartigan, et al. discloses the use of a method and system for tracking and reporting time spent on tasks in different application on the end users' computers while the tasks are bing performed. It may track the opening and closing of files automatically and send reports and messages directly to and from other applications. The software may also suggest categories for each task based upon at least one criteria. The system may use MS Outlook for assistance in tracking tasks and transmitting reports. It is directed toward attorneys and accountants. The system may track fixed fees and use data collected for evaluating production or sweat equity bonuses to employees. The system may track a plurality of projects or research endeavors. It can track the time spent by accountants on spreadsheets. It can track the time engineers spend on designing computer code or simulating circuit designs, etc. It mentions the use of Timeslips for professional time tracking and TABS II for tracking other professional time spent on tasks and projects. The system tracks time on computers used by the professionals involved. The system presents toolbars to assist in tracking time. The system will track time spent in applications such as MS Word, Excel, Outlook, Power Point, etc. It will track when the application is open, active and then closed. It can score and rate the usage of these various types of software automatically. Various reports may be generated by the system for management usage on a periodic basis, as desired.

WPO Patent Disclosure No. 2015/079776 to Hishiki discloses the use of a work state management system that manages clock in times for drivers of vehicles that work overnight shifts and calculates the appropriate breaks for the driver so that the driver is not over tired.

U.S. Patent Disclosure No. 2014/0344,122 filed by Hodgin, discloses the use for billing for time spent in an IM session by a service person wherein the system can automatically bill a project/client by searching for the name of the client or project within a text or instant message or a series or session of same. If the system cannot find the name of a client or project, then the user will associate the IM session with a new project or client so that the client may be billed for the IM session with the client. Or the System may default into a common template for the User's typical instant messaging sessions.

U.S. Patent Disclosure No. 2009/0006228 filed by Hodgin discloses the use of a time tracking system and method similar to the IM system noted above by Hodgin. The Hodgin system will also store a list of prior associations to Projects and Clients that are built on the same or similar words and phrases.

U.S. Patent Disclosure No. 2002/0154122 filed by Jackson, Jr. discloses the use of an improved system for employers, referral agencies, consultants and independent contractors to hire and manage employees and provide tax reports and wage reports. The Jackson, Jr. System may track and manage employees, salaries and experience to provide optimal benefits to the employer. The System produces computerized scheduling, billing, record keeping and payment templates. It provides a listing of invoices for the User to refer to. It consists of providing invoices for contractor services and performs its functions in a cloud based system.

U.S. Pat. No. 8,838,486 issued to Kong, et al., discloses the use of a time manager interface on a communications display device which allows a worker to keep track of her or his time and activities. The time manager keeps track of time spent logging into and out of the system. This was important in years past when boot time were quite long. It discloses the use of scanning in employee badges to track work time. This disclosure is directed toward a system for checking work in and work out time. In one version of an embodiment, the System is located in the field. It discloses the use of GPS in the field to create an audit trail of time worked. Biometric information may be used for the system to identify the worker. It can be used nationwide for multiple local offices. It may be coupled to communicate with employee hand held devices. It can work over WiFi and cellular networks. It can store: DOB, SSN and other employee details. It can be used with a barcode or QR code. It can be used in connection with microphones, cameras and scanners. For remote sites, the system can check the IP address of the computer or hand held device to ensure security in the system. The system can also be used to check work schedules to lock an employee out of the system when not scheduled. When an employee arrives at a worksite, upon verification, one or more emails or text messages may be sent to management for that site. Employees may view the work schedules of other employees if granted permission to do so. In doing so, employees can request work dates and exchange them with others. The system can differentiate between exempt and non exempt employees. The system can display messages to employees during time in and time out registration.

U.S. Patent Disclosure No. 2012/0278211 filed by Loveland discloses a system for remotely tracking and monitoring Worker's activities via mobile phones or other mobile tracking devices. This system monitors continuously whether or not a worker is present at a worksite.

WPO 2010/11652 filed by Manser discloses a System and Method for tracking employee performance. The Manser system provides a user interface to allow the user to assess the balance of hard skills and soft skills of an employee, evaluate the employee's performance in a plurality of categories and compare the average cost for the job in the marketplace to the cost of the employee being evaluated. The system also analyzes the average cost of a similar job in the relevant marketplace during employee reviews. The program continually monitors the value of an employee to the employer to determine ROI at any given time. The system can be applied to direct hires, contractors, temps or any employee relationship. The system allows the identification of both over achievers and under achievers. The system provides a means by which employees may determine how to get the highest ratings via their work efforts.

EP 2338293 filed by Molotsi discloses a system for time tracking for employers on a mobile computing device. The system involves providing an event manager on a mobile computing device for managing a plurality of events which are then synchronized to a server. The system will automatically track time and estimate time spent on a task by the worker. This system logs events in the user's calendar, in emails and texts. Timestamps for events and mapping for the events are provided. A client list and data may be provided in one or more files or databases. The system may communicate with a worker's smartphone. The user may be able to open, edit, delete, review or manage all automatically created event records. The system may use information in the text, email, and calendar to automatically create a time tracking record for the user. In addition, the system may automatically convert emails, texts, meetings on a calendar to a time tracking event by means of a pop up box to the user.

WPO 2008/061146 filed by Neveu Holdings, LLC discloses a system and method for remote time collection for employee time on job sites. The system can collect an employee's name, picture, title, contact information, health and/or safety information, skill information, etc. The system can also collect for each employee a project name, project identification, location, project start date, project supervisor and detailed comments about project activity. The system can also collect information on vendors, such as name, address, phone, contacts and type of vendor. The system can also use GPS information and compare it with when the employee is supposed to work. The system collects biometric information to identify an employee. In one embodiment, a time collection database is configured to receive, process and store information related to projects such as name, identification, location start date, supervisor, etc; vendor's name, address, number contact, subcontractor type, etc. project supervisors, tasks, employee titles, departments and employee time records. Office data collection may include: job site, task and project information via a wireless connection. Encryption is used to transmit data to and from the remote site. The system may also include a field scheduling module to schedule a job for a particular jobsite and for a specific remote user(s). The user can edit hours and view comments from remote workers. Remote monitoring can record task completion, view management comments and ask for management assistance and crew responsibilities.

U.S. Patent Disclosure No. 2015/0081381 filed by Okoba discloses a system and method for recording time which may be used on a device, software or application. It may be used by logging into a plugin or extension. The time recorded may be exchanged for vouchers which may be redeemed or traded with other members. A user will register with an ID and password to log into the system. The system may record device activity, software activity, application activity, keyboard activity and mouse activity. The user's time spent in the browser or on a video game may be given a redeemable value. A database may store the recorded activity for further analysis. The system will work on computers, tablets, cell phones, television, games, digital books, exercise apparatus, web browsers, mobile apps and video games. Vouchers may represent monetary value, promotions, products or services. User name and password may be stored in system cookies. The system can capture video game or browser activities, keyboard or mobile keyboard activities. The activity spent in the system may translate to purchasing power so that the user may receive optimized value from their activities and the system may deliver purchasing incentives at the right time and place and for the right product or service. A business maybe selected as a favorite from user activity on the system.

U.S. Patent Disclosure No. 2015/0081487 filed by Porter, et al., discloses the use of a time tracking and productivity system including a tracking component to locate an employee to record time spent at various locations. This system is designed to monitor and improve coordination of patient care, and in particular, to limit the number of patient hours a resident physician can work per week. When the rules implemented by the ACGME are violated, strict fines and probations or suspension may be implemented. This system is primarily concerned with tracking an employee's location and work hours. This system can include cloud performance. It is the movement of an employee within predetermined boundaries that will trigger the recording of a new event. It can track time in a patient's room, a brake area, doing paperwork, etc. A GUI is used on handheld devices. The system can also use tags that interact with RF signals. The system records employee info and FRIDA numbers, the resident program director, the resident coordinator, start and end times for resident shifts, house calls, hospital room calls, night float, etc. If moonlighting is permitted, the system can track moonlighting hours as well. It will store vacation schedules and rotation schedules. The shift log can include a short trip buffer. Automatic warnings of over limit hours are sent to management for the residents via text, phone, email, etc.

U.S. Pat. No. 6,185,514 issued to Skinner discloses a method and system for automatically collecting and analyzing information regarding time and work performed on a computer. It uses a data collector for monitoring certain potions of a worker's computer activity and an analyzer for showing which portions of the activity were continuous work activities, and the system will categorize the work into preset projects and tasks within a project. The information is periodically written to data storage. The system is directed toward telecommuters. The system automatically excludes time where there was no activity on a computer. The system is used to forecast future projects with reduced financial risk. The system includes the automatic documentation of time. The data stored on the system is encrypted so that it cannot be altered by the user. The data collector automatically collects the activity on a mouse and on the keyboard of the computer user. The system creates a log file of work activity. A hardware abstraction layer can interface with phones and other devices and can be used with pointing devices such as a tabled or mouse. The system keeps track of activities within open multiple windows on a computer.

U.S. Pat. No. 8,209,243 issued to Smith, et al., discloses the use of a system for performing real time labor management and timesheet reporting which is adapted to wirelessly transmit timesheet information. The portable devices may be dedicated to tracking time only and cannot perform other computing functions. The system includes a portable electronic punch system that is capable of communicating with the labor management system via text. The system allows user to manage work schedules and report timesheet information without requiring an internet accessible computer. The units send timesheet information directly back to the server for analysis via wireless network. The text messages may contain: employee ID, clock in time, clock out time, break times, days worked, days off and other work related information. New user information may be set up by text message into the timekeeping system. The system may operate over any wireless system, i.e., GSM, GPRS, CDCP, Bluetooth, Wifi, etc.

U.S. Pat. No. 9,020,848 issued to Ridge, et al., discloses the use of a method for tracking time and location of an employee according to a predefined schedule and it may utilize software to track the presence or non presence of: a NFC (near field communication), BLE (Bluetooth Low Energy) or other wireless device. The system will track the presence of an employee in a geofenced area. It will also track employee time and other data to log that into a payroll system. The low energy device then communicates data to a server if a signal could or could not be detected. It will also allow for manual clocking in and out in case of failure of the back end server. The system can also be used for security purposes. The system can function in real time or in batch request mode. The information may be a time stamp, a status or location of a mobile device. In one embodiment, the system can be used for employees for a retail store or restaurant. The system can utilize Bluetooth tapping to log in. It may be used at a trade fair both by tapping the device to a NFC communicator. It maybe used in connection with a mobile time clock app. It can be used to advise management when non authorized employees enter a restricted work zone. Management may input which work zones are restricted and which are not.

WPO Disclosure 2015/029073 file by Shirish discloses a system and method to measure aggregate and analyze time, effort and productivity by reviewing time spent on activities such as calls, travel, lab work, meetings, discussions and remote visits. PD's or Presence Devices may be used to track employee location. The system can track average daily work patterns. It can track work activities and private activities. It can track emails and browsing. It can account for flexible work hours, use of multiple and different types of computing environments (PC at work and home, smartphones, tablets, etc.) It can capture files, folders, web links, etc. It can make all personal endeavors password protected and private. It is intended to track effort and performance 24/7. It can provide modules that promote work focus and minimize distraction by awarding performance points, badges for consistent performance and progress in performance goals. It can measure improvement by creating an n-dimensional effort data cube and include analytics for custom reports. The system can go into self improvement mode to set goals for self improvement and activities related thereto. It can be used at work whenever and where ever. It has a time tracker for all online time. It has a Merger to merge offline and online time effort mapping. It has an interference engine to determine Work Patterns for employees, leave taken, work done on holidays, desk or supervisory or travel oriented job, etc. The System will also present organization goals and analytics, top performers, work patterns, recent deviations from work patterns. A Collector module measures data to improve the exact work effort at the individual level throughout the day. The System can be used on SAS (Software as a Service) and it maybe hosted in a cloud-computing environment.

U.S. Pat. No. 2012/0173297 A1 disclosed by Styn, et al., a method and system for task tracking and allocation is disclosed. The disclosure provides for a method in which an individual may create a set of instructions operable to perform a set of tasks in a computer readable medium. That set of tasks may comprise maintaining a database, generating a first interface displaying subjects associated with individual issues, and a second interface with notes specific to an issue selected by a user. The instructions stored in the database may be implemented accordingly and the computer may maintain a plurality of relationship records containing data indicating relationships across folders. The disclosure also mentions the prior use of MS Project and ERP systems that employ Gantt charts, milestones and tasks and subtasks with complex dependencies. This system keeps track of billable items. However, Van Styn is not a true timekeeping and professional billing system.

US Pat. No. 2014/0108644 A1 disclosed by Zaents, et al., a method and system for tracking time in a web-based environment is disclosed. The method of tracking time involves a web-based application to track time associated with several records. Identifying a record in an active state, generating a record associated with the active record and activating a timer, and having the ability to end the session in response to an indication that the record is an inactive state. The time-tracker may be hosted in a cloud-computing environment. The time-tracker may calculate the entire duration of the record by continuously adding the active times together. The method may detect a predetermined total duration of time has been exceeded and provide such indication to user. This disclosure mentions timekeeping, billing and using a web browser and multiple tabs to record time for multiple clients when a professional is switching back and forth between projects. It is useful for billing, accounting and auditing. More than one user can log into the system on a computer and track time her or his time on the same computer. It also teaches the use of sub-tabs to track time. A stop watch type button is used to switch on and off the time tracking, or time is tracked as the user switches browser windows.

In US 20140201138 A1 is disclosed a system and method regarding the functionalities, features, and user interface of a synchronization client to a cloud-based environment. The disclosure describes a method to keep different versions of documents synchronized between the local device and the cloud-computing environment. Embodiments of the prior art include systems and methods for a synchronization client that is connected with a collaboration environment including a cloud-based environment and runs on a client device such as an iPad.

In reviewing the prior art, there is disclosed in US 2013008062A1, a method and system for the management of professional services project information. Disclosed in the prior art is a method for improving the accessibility and transferability of various data or information resources used in the management of a business. In one embodiment of the prior art, is a computer network for managing a business, consisting of a computer network, CPU and processor and one or more distributed application means, data cooperating with said one or more distributed applications means, and data storage means, and project management database means cooperating with one or more distributed application means for facilitating the transfer of said data from said one or more distributed application means.

Further, U.S. Pat. No. 20110054968 A1, Galaviz discloses a system for continuous performance improvement. The prior art discloses a management approach to employee productivity and quality assurance to clients. In one embodiment of the prior art is a computer-implemented method for continuous performance improvement, the method includes providing visibility of project documentation and allows for collaboration and version control for the project documentation, this is done over a web-based workspace.

Similarly, in U.S. Patent No. 20140095539 A1, Smit et al. discloses, a system and method for asynchronous client server session communication. The prior art provides a system that offers a highly effective solution to the aforementioned disadvantages of both client-server and Internet systems by providing a way to synchronize the data entered on a client system with the data on a server. Data input by the client are transferred to the server, and the server updates the client display. A plurality of servers can be used to serve a number of static or dynamic sources. Data can also be presented to a client without user input, meaning the data are automatically pushed to the client. This enables a client component to display the data immediately, or to transmit the data to another program to be handled as required.

Thus, nowhere in the prior is seen an improved system for managing financial and other business data through the use of sophisticated coding wherein reports can easily encompass a plurality of divisions and related corporations so the data may be easily analyzed between sibling corporations and easily rolled up to the global corporate level or rolled across to other related corporations. Also, the prior art does not disclose the ability to run reports and track company data between divisions and departments, and in the case of mergers and acquisitions.

### SUMMARY OF THE INVENTION

The present invention consists of an improved Method for Managing Businesses with a Single Office or Multiple Locations where the various items of company data, including financial, inventory and work data, are encoded in such a detailed manner, that when running a plurality of businesses the data may be rolled up to a global corporate parent, or it may be easily viewed and analyzed between sibling corporations or related corporations such that the management of the business both vertically and horizontally is vastly improved. Typically, in the past, each office kept its own system of data management for all aspects of running its business: income, expenses, inventory, workers, etc. were all reported on one system and in house. There was no uniform coding which included a Location Code, an Office Code, a Division Code, etc. in order for reports to be commingled, rolled up in order to make management possible between different offices, sibling corporations, divisions and business associations and then roll the data-financial and otherwise, up into a main global corporation.

In the present invention, all aspects of data, from time and billing, inventory, vendors, workers and work data is coded in such a manner and uniformity, that reports can be run for one Office, City, Region or Country, practice group, timekeeper or for multiples of these categories. In such a manner, financial and other reports maybe rolled up conveniently to one global or corporate partner for further analysis or reports may be rolled across for analysis by management in related corporations. This inventive System and Method is extremely flexible and will work with virtually any type of organization of businesses and locations that could use assistance from management in order to optimize profitability and lower costs and expenses.

In one preferred embodiment of the present invention, the Improved System and Method for Encoding Business is a global law firm, and the various categories of business data for workers consist of time worked, timekeeper, work date, matter, phase, activity, task and description may be coded with a work group or Area of Law which allows for management to determine which Local Practice Groups or Regional Practice Groups or National Practice Groups have Workers lacking capacity and which have excess capacity, such that work may be transferred between individual Offices located anywhere around the world. All company data, from Management and Timekeepers to cost centers and every department is encoded with tracking codes so that a much wider variety of data may be reported upon and analyzed by management to increase profitability of the company or firm.

In the case of a law firm, the client will first be notified that the work may be eligible for a transfer to another office and may be eligible for a discount and that more information may be provided on the Resume, Curriculum Vitae or skills sets of the professional workers involved. The present invention is suited to many types of professional firms including law offices, architectural firms, engineering firms, accounting firms and other consulting firms where time and costs are billed out to a client or customer. The Time Worked Data fields may be encoded with the Local, Regional or National Practice group, wherein the System may keep track of all time recorded and billed, noting when a Local Practice Group or Office will be able to take additional work. To induce the client to use new attorneys and support staff, the client will be offered a discount for permission to utilize these individuals.

In typical global law firm corporations, the organization is tracked in the following categories: Global Data, Regional (where Global is treated as a Region), Formula Units, Country, Legal Entity, Local Office, Local Practice Group, Local Sub Practice Group, Timekeeper and a Chart of Accounts. In addition, there may be found the following categories of Work Data tracking: Company Code, Profit Center, Cost Center, Purchasing Organization, Sales/Billing, Distribution of Services and Divisions of the businesses.

These are defined as follows:

Organizational Structure Element Definitions

Company Code (Legal Entity)—Company Code is the smallest Organizational Unit of accounting for which a complete, self-contained set of accounts can be created. This includes the entry of all transactions that must be posted and the creation of all items for financial statements, such as Balance Sheet and Statement of Profit and Loss.

Profit Center (Office Code)—An organizational unit in Accounting that serves as an accumulator of revenues and expenses which will be mainly used to derive reports by local office units.

Cost Center (Sub-Practice Groups, Admin Practice Groups and Global Cost Centers)—An organizational unit that represents a lowest level attributes to capture expense transactions. Timekeeper direct expenses will be captured at a relevant Cost Center. Each Cost Center is assigned to a Profit Center and a Company Code.

Sales Organization (Legal Entity)—Enables Sales and Billing functions for the Organization. Time and Costs are processed within Sales Organization using Draft Bill and Final Bill. Clients are created or extended to Sales Organizations. Each Sales Organization is assigned to exactly one Company Code to which all Sales must be posted. A Sales Organization may have one or more Plants (Office Codes).

Distribution Channel—An Organizational Unit that determines how services are billed and how they are distributed (For Project One only the default Distribution Channel will be used).

Division—An Organizational Unit that is assigned to a Distribution Channel to organize service lines (For Project One only the default Division will be used).

Plant (Office Code)—An Organizational Unit which along with Sales Organization establishes the source of service (Billing Office and Working Office) and the relationship of Member Firms vis-à-vis Inter-firm activity.

Personnel Area (Office Code)—An Organizational Unit that organizes business aspects like personnel management, time management and payroll. Timekeepers are assigned to a Personnel Area.

Personnel Subareas—An Organizational Unit that represents Local Practice Groups.

Purchasing Organization (Legal Entity)—An Organizational Unit responsible for the procurement of Goods and Services. The Purchasing Organization represents the procuring unit in a legal sense.

However, in the past, global and national law firms with multiple locations did not encode all worker data, inventory data, cost center data, profit center data in an uniform style and with uniform coding such that reports could be easily run at the global level, national level, regional level and office location level such that management could capitalize on excesses in inventory, workers, office space, overhead, etc. and that could be transferred into Locations which are currently underutilized. Furthermore management will be able to view these reports in a manner that has never been possible before with this ease.

When each of the above areas are tracked by the number of workers and the amount of work performed on a business day, the System can analyze if work can be transferred from one Office to another Office, even if the transferee Office is located in a different Location, Region or Country. The System can do likewise for inventory and office space, FF&E (fixtures, furnishings and equipment) and any other business data that management might find interesting to utilize to optimize profitability and decrease operating costs.

With the Present Inventive System, trends in Work Load can be analyzed and plans to transfer work in advance to a different Location, Region or Country can be made in advance of excessive work load, or inadequate work load, without the need to hire or fire employees, which can be very costly to any business organization. Or, any Manager or Timekeeper can flag the system for additional work when the Timekeeper has determined there is additional capacity the Timekeeper may add to her or his workload.

In one embodiment of the present invention, the system may be set up to take into consideration, the importance of client and customer contact in professional corporations such as lawyers, accountants, architects and engineers, the client or customer will be contacted first prior to any transfer, and the client's consent will be solicited, generally in exchange for a reduction in hourly rate, fees or time to complete a project. The client or customer will be provided with the following: Resumes or Curriculum Vitae of any new professional working on the matter, the location where the work will be performed, any tax implications, attorney client and other legal implications and then the Client will be asked to sign off on the transfer of work to another Corporate location. In addition, permission to transfer any client or customer work may be provided in advance in a Client Fee Agreement or Engagement Agreement.

The System may also provide the reviews or rating of the new workers to the client. These may be gathered from other in house professional, other professionals in the area not part of the corporation who have reviewed the workers, or online public data. If the in house or public ratings for a particular worker become unacceptably low, the worker may be disqualified from the Work Transfer System until her or his ratings improve.

A worker may request additional work by Matter, Client, Client Group, Phase, Activity or Task. One sister company may request to purchase unused, overstock or discounted furnishings and fixtures (furniture, computers, software, etc.) from another sibling corporation or even the global parent corporate offices. Excess office space can also be utilized by sibling corporations who may want to move administration or staff services to a country or region where workers are cheaper and office space is also discounted.

Finally, in order to determine accurate profitability, costs may be assessed against an Office Location, Region, Nation, practice group or subpractice group of a Timekeeper or even down to each timekeeper. For example, to gain access to costs of the US patent practice group data, a vendor may charge $25,000 per year. With the present inventive system the $25,000 per year may be charged against all attorneys on a per capita basis that are registered patent attorneys. Or, only patent attorneys may be charged but only according to the hours they utilize the system. A third method for allocating expenses against a patent group or subgroup might be to charge the attorney according to billable hours spent on generating patent application. In the past, the entire $25,000 could only be allocated across the number of Office Locations providing patent services and it could not distinguish between offices locate in rural US areas which have nearly no patent attorneys, versus Washington, DC, New York and Chicago which have about 80% of the patent attorneys in the US. Furthermore, this data will allow the business to determine profitability through this data and any other costs or profits. This allows the management to determine what to do about these costs whether to pass them on to clients, or to increase the billable rate for attorneys in this practice group who have this expense, or whether to eat the costs. These business decisions are made possible by collection of this encoded data that allows the reporting to be viewed across practice groups, or by offices, or by sub practice groups in order to maximize profitability.

Similarly, most firms have malpractice coverage. In rural areas the rates can be much lower than large cities. In addition, some areas of law have much higher rates (Patents, etc.) than other areas such as pro bono—no court appearances. In such a manner, those costs may be pro rated and charged per capital against the Timekeeper and his practice area. In the past, malpractice insurance was done on a per Office Location basis.

By being able to analyze data down to the level of Timekeeper, Practice Group, Sub Practice group, etc. Management is much more fully informed of costs incurred at every location by every Timekeeper and staff and cost center. Profitability reports are a different type of bookkeeping method separate from GAAP (Generally Accepted Accounting Practices, often used for annual reports) and FIT (Financial Income Tax, used for taxing purposes only), yet in the case of partnerships and corporate law firms, profitability among partners is a delicate, intricate matter to ensure that all partners believe their accounting and profit sharing has been treated fairly.

The present invention, while of vast importance to businesses have a presence in more than one location and with a global parent corporation is also adapted to situations with only two or three office, or even only one office. By having the system implemented with advanced coding in a first and only office, it will make acquisitions and mergers more attractive for other similar business looking to acquire or merge with other similar businesses for the purposes of economy, optimizing profits and sharing expenses. This type of reporting is not possible without the unique organizational structure of this invention.

The present invention, while directed to Firms and Companies, is easily adapted to be used by a wide variety of business types, including, but not limited to: corporations, business ventures, partnerships, organizations, NFP's (not for profits), LLC's, PC's, Swiss Vereins, GmbH and all other types of methods for organizing businesses and each of these terms should be considered to be fully interchangeable with one another.

Although the foregoing summary has set forth specific embodiments of the present invention, numerous other additions and substitutions may be found to be common in the prior art and obvious to try shall be included in the above summary as if set forth fully herein.

### OBJECTS OF THE INVENTION

Thus, it is one primary object of the present invention to provide an Improved System and Method for the Optimal Management or re-allocation of resources, inventory and work within a Corporate Organization having a single office or multiple offices, and in particular, Offices in a plurality of cities, states, regions and countries wherein Company Data may be analyzed at the top Corporate level, or at the local level, and Company Data is intricately coded such that it may be rolled up or rolled across related corporations for enhanced reporting and management purposes.

Still a primary object of the present invention is to provide an Improved System and Method for the Optimal Management or re-allocation of resources, inventory and work within a Corporate Organization having multiple offices wherein detailed reports may be run by Practice Group or Sub Practice group and costs may be assigned or allocated down to the level of Timekeeper for reporting purposes across companies, divisions, Cities, Regions and Nations.

It is yet a further primary object of the present invention to provide an Improved System and Method for the Optimal Management or re-allocation of resources, inventory and work within a Corporate Organization having multiple offices wherein a client or customer may receive a request from the System to re-allocate work from one location to another, the communication will provide all the implications of transferring the work from one location to another and the client may respond in an electronic communication or with an electronic encoded signature authorizing the transfer of the re-allocated work.

Still a further primary object of the present invention is to provide Improved System and Method for the Optimal Management, including maximizing profitability, re-allocation of resources, inventory and work within a Corporate Organization having multiple offices wherein the client is informed of the implications of transferring work wherein the following topics are discussed: attorney client privilege, tax changes, rate changes, and any additional fees and costs associated with the transfer.

Still a further primary object of the present invention is to provide an Improved System and Method for the Optimal Management or re-allocation of resources, inventory and work within a Corporate Organization having multiple offices wherein individual workers or Timekeepers may flag the System to request additional work or additional assistance with their work load, and the request may be made by specific reference to one or more of the following: Client, Client Group, Matter, Phase, Task or Activity.

An additional primary object of the present invention is to provide an Improved System and Method for the Transfer or re-allocation of work within a Corporate Organization having multiple offices wherein prior to a reallocation of any work, the client is invited to review first any ratings available on the new workers including reviews generated in house, reviews generated by other clients and customers of the Company, reviews generated online or by the public.

Yet an additional primary object of the present invention is to provide an Improved System and Method for the Optimal Management or re-allocation of resources, inventory and work within a Corporate Organization having multiple offices wherein prior to a reallocation of any work to be performed, the client or customer is first provided with a copy of the worker's Resume, Curriculum Vitae, list of professional publications, list of professional activities and all other necessary information to make an informed decision regarding the transfer or reallocation of any work

A further primary object of the present invention is to provide an Improved System and Method for the Optimal Management or re-allocation of resources, inventory and work within a Corporate Organization having multiple offices which may, when a reallocation of workload has been determined for a particular Location, advise the client or customer of all advantages in the transfer of work, including reduced rates, more expedient response time on a Matter, Task or Activity.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 shows a flow chart of the Present Invention, Improved Work Load reallocation between offices in a Global Organization.

FIG. 2 shows a system chart of a business organization implementing the Present Invention, Improved Work Load reallocation between offices in a Global Organization.

FIG. 3 shows a system chart of a business organization implementing the Present Invention, Improved Work Load reallocation between offices in a Global Organization.

### DETAILED DESCRIPTION OF THE DRAWINGS

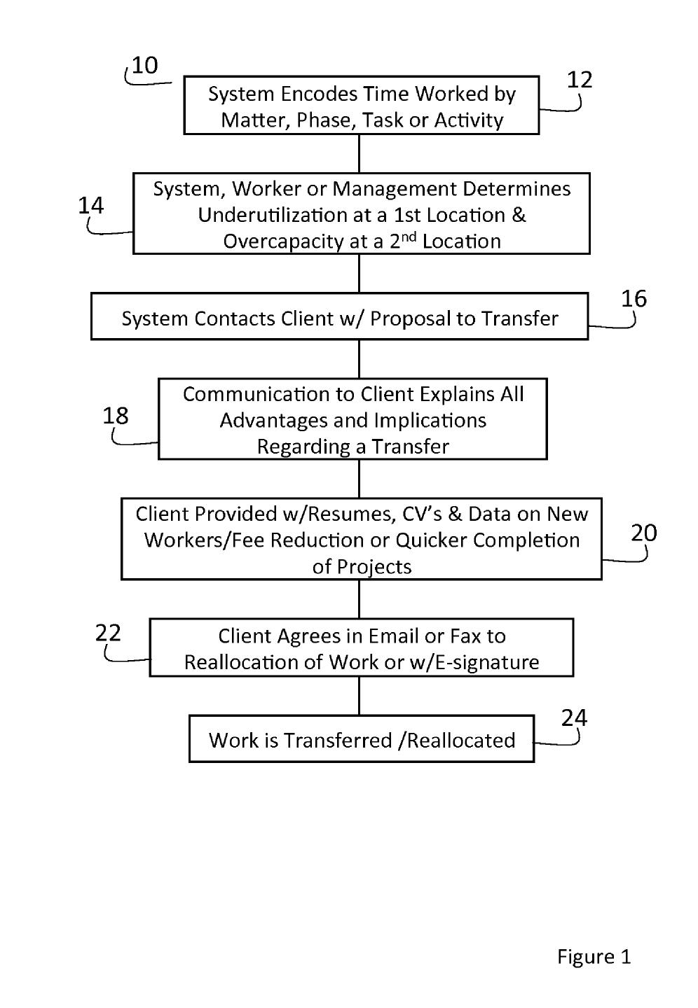

Shown now in FIG. 1 is Improved Method for the Optimal Management of Worker Data in a Global Organization 10 showing means for the System encoding Time Worked Data by Client, Client Group, Matter, Phase, Task or Activity 12. When the Work Data is encoded in such a manner by Timekeepers, this Work Data may be accrued or accumulated at the Office level, City level, Local and Regional Level and then each of these can produce a total sum at the Global level. Next, for a given time period, the System may automatically calculate whether any Timekeepers or Offices are under or over utilized at given offices 14 and where appropriate, the System can initial a process for transferring or reallocating work from a first office which is operating at over capacity levels to a second Office(s) which appear to be underutilized. The System will contact each of the Client involved and query them if a transfer is possible 16. The communication to the Client, which is preferably electronic in nature, such as a fax or email, will explain all advantages and implications involving a transfer of work from one location to another 18. In the case of a law firm, when a transfer is intra state, generally there are few or no implications since most legal work is territorial in nature by State license. However, when the work transfer crosses state lines, there may be a number of implications which must be explained to the client, including taxes, licensing of different workers in different states and other necessary considerations attendant to a change of venue for the work involved. The changes for a global change in the work location from one country to another may have significant implications, including loss of attorney client privilege for those countries which do not have such protections.

In advance of approval for the transfer or reallocation of work, the Client will be provided with copies of the new worker's resumes, curriculum vitae, a list of their publications and awards, if any, so the client is fully informed of the transfer 20. In addition, the Client will also receive notice of any advantages to the transfer such as quicker project completion time, reduced rates, reduced taxes, etc. Next, the client will agree in writing to the transfer, which is preferably accomplished via email or fax with an electronic signature 22. The work or portions of it, are then transferred to the new city, state, region or county. The result of the flexibility in efficient work transfers means fewer unnecessary hiring and firing of employees, which is typically considered disruptive, costly and undesirable.

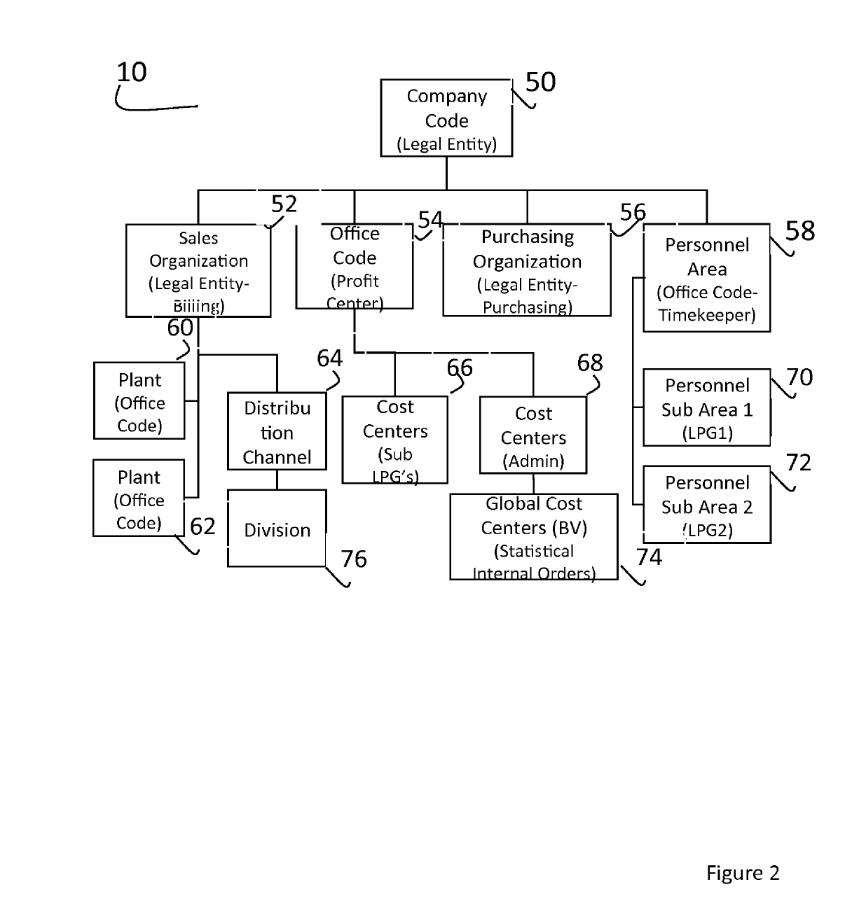

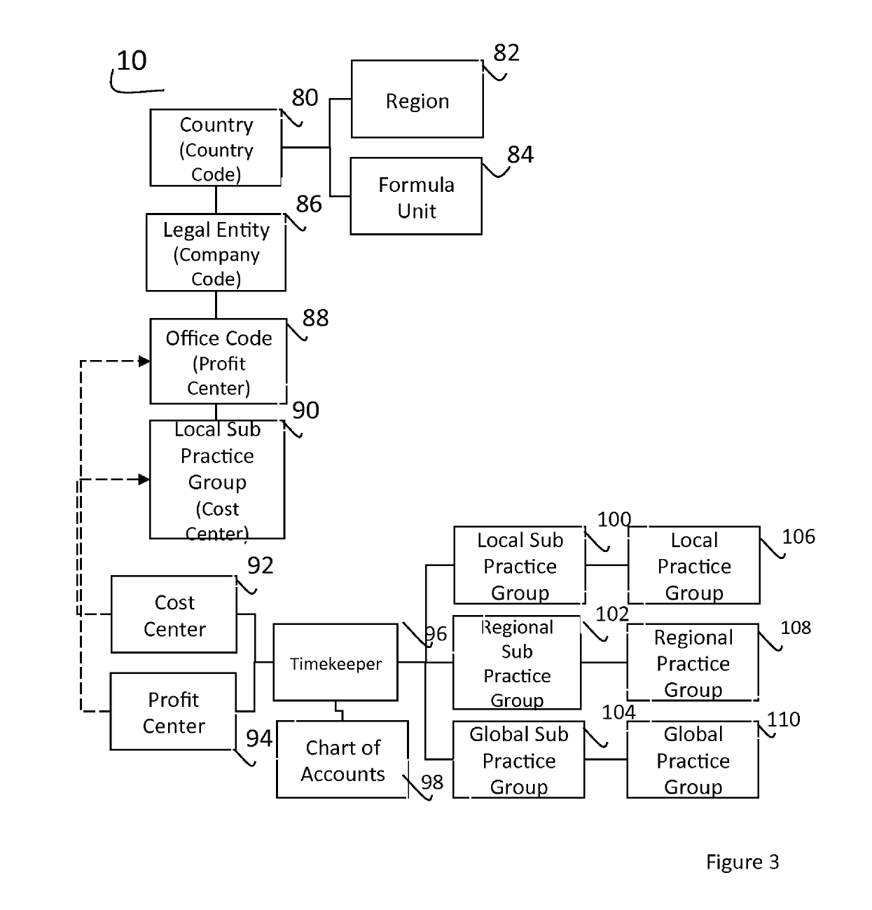

FIG. 3 shows a system chart of a typical Financial reporting structure for a global corporation having offices in multiple nations. In FIG. 2 is shown the Optimal Management of Worker Data in a Global Organization 10 having a country (country code) 80 which communicates with a Regional office 82 and a Formula Unit 84. The country Office 80 also then communicates with an individual Legal Entity having an ID or Company Code 86, which in turn communicates with or reports to a specific Office having an Office Code 88 which is considered a Profit Center. This Office 88 in turn is provided with a plurality of Local Sub Practice Groups 90 which are also Cost Centers. Ecah Timekeeper 96 is associated with a local Cost Center 92 and a Profit Center 94. The Cost Center 92 records salaries and expenses, while the Profit Center 94 records or tracks time billed and collected for Timekeeper 96.

In turn, the Timekeeper is linked to a Local Sub Practice Group 100 and a Local Practice group 106. In addition, the Timekeeper 96 is linked to a Regional Sub Practice Group 102 which is linked to a Regional practice Group 108. Still further, Timekeeper 96 is linked to a Global Sub Practice Group 194 and a Global Practice Group 110. The Regional and Global tracking can generate reports for Timekeeper work outside the

Local Practice Group 106 which have been transferred or re-allocated to the Timekeeper 96.

FIG. 2 shows on preferred embodiment of a system chart the Optimal Management of Worker Data in a Global Organization 10 having a Company Code 50, then sub organizations of Sales or Billing 52, a Profit Center or Local Office 54, a Purchasing Organization 56 for supplies and Furniture, Fixtures and Equipment, and a Personnel Area 58 which is also a cost center. In addition each Sales Organization 52 is associated with a plurality of Plants 60 and 62 which report to it, a Distribution Channel 64, a Division 76 which also report to Sales Organization 52. Next Profit Center or Office Code 54 has the following entities reporting to it: Cost Center or Sub Local Practice Groups 66, a Cost Center for Administration 68 and a Global Cost Center (which may be a BV, a Swiss Verein, a GmbH or other foreign entity, which is an SIO or Statistical Internal Order 74. Finally, the Personnel Area 58 has the following entities reporting to it: Local Sub Practice Areas 1-70 and Personnel Sub Area 2 or Local Practice Group 72. By structuring a Global Organization in this manner for reporting purposes, it is entirely possible to transfer or reallocate work in a Global Organization and accurately track Work Performed, and profits and expenditures across Local, Regional and National Offices.

Of course, the present system for generating and implementing a fee agreement may be applied to any or all of the following types of businesses in the US or around the world: Corporation, Company, Partnership, Business Venture, Business Association, LLC, LLP, PC, Swiss Verein, GmbH, NFP (Not for Profit) an unincorporated business association or venture.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

What is claimed is:

1. The Improved System for Optimal Management of Worker and Business Data with Detailed Encoding, wherein the System is provided with a CPU and data storage unit, the System being provided with at least one Business Information Category of: Work Data for Workers; Financial Data comprising Income and Expenses, Inventory Data comprising an inventory of Tangibles and Intangibles owned by Company; encoding the Business Information with at least one of the following Business Office Codes: Worker ID, Office Location, Local Office ID, Regional Office ID, City Code, Practice Group and Sub Practice Group; the System generating reports of Business Information by one or more Business Office Codes for the purposes of optimal management of the Company.

2. The Improved System for Optimal Management of Worker and Business Data according to claim 1 further having means to run reports by Practice Group, Worker ID and by Sub Practice group for the purposes of optimizing profitability of the business organization.

3. The Improved System for Optimal Management of Worker and Business Data according to claim 1 further having means to allocate costs and expenses by Worker ID, Office ID, Region ID, City Code and National Code for the purposes of optimizing profitability of the business organization.

4. The Improved System for Optimal Management of Worker and Business Data according to claim 1 further having means to contact a customer prior to transfer of any of the customer's work and request written authorization for the proposed transfer of work from a first Office to a second Office.

5. The Improved System for Optimal Management of Worker and Business Data according to claim 1 further having means to inform the client of any advantages and implications regarding the transfer of work from a first Office to a second Office.

6. The Improved System for Optimal Management of Worker and Business Data according to claim 1 wherein the System may roll up income and expenditures according to one or more of the following criteria: Worker ID, Practice Group, Sub Practice Group, City ID, Region ID and National ID for the purposes of determining profitability.

7. The Improved System for Optimal Management of Worker and Business Data according to claim 1 wherein the System may roll across sibling related corporations having income and expenditures according to one or more of the following criteria: Worker ID, Practice Group, Sub Practice Group, City ID, Region ID and National ID for the purposes of determining profitability.

8. The Improved System for Optimal Management of Worker and Business Data according to claim 1 wherein prior to the transfer of work, the client is informed of one or more of the following Worker Data at the second Work Office selected from the group comprising: a Resume, a Curriculum Vitae, a public review of a worker at the second Office, an in house review of a worker at the second Office, a list of worker licenses and a list of worker professional publications.

9. The Optimal Management of Worker and Business Data according to claim 5 further having at least one worker with a work rating wherein when any worker at the second office has a work rating flagged by the System as being too low, the worker's name will be excluded from a Work transfer listing.

10. The Optimal Management of Worker and Business Data according to claim 1 wherein a Worker in the first office may trigger a flag in the System that the Worker is at under capacity for work.

11. An Improved Method for Optimal Management of Worker and Business Data with Multiple Offices, the Method having the steps of providing a CPU and data storage, providing the System with at least one Business Information Category of: Work Data for Workers; Financial Data comprising Income and Expenses, Inventory Data comprising an inventory of Tangibles and Intangibles owned by Company; encoding the Business Information with at least one of the following Business Office Codes: Worker ID, Office Location, Local Office ID, Regional Office ID, City Code, Practice Group and Sub Practice Group; the System generating reports of Business Information by one or more Business Office Codes for the purposes of optimal management of the Company.

12. The Improved Method for Optimal Management of Worker and Business Data according to claim 1 further having the step of: running reports by Practice Group, Worker ID and by Sub Practice group for the purposes of optimizing profitability of the business organization.

13. The Improved Method for Optimal Management of Worker and Business Data according to claim 1 further having the step of allocating costs and expenses by Worker ID, Office ID, Region ID, City Code and National Code for the purposes of optimizing profitability of the business organization.

14. The Improved Method for Optimal Management of Worker and Business Data according to claim 1 further having the step of contacting a customer prior to transfer of any of the customer's work and requesting written authorization for the proposed transfer of work from a first Office to a second Office.

15. The Improved Method for Optimal Management of Worker and Business Data according to claim 1 further having the stop of informing the client of any advantages and implications regarding the transfer of work from a first Office to a second Office.

16. The Improved Method for Optimal Management of Worker and Business Data according to claim 1 further having the step of rolling up income and expenditures according to one or more of the following criteria: Worker ID, Practice Group, Sub Practice Group, City ID, Region ID and National ID for the purposes of determining profitability.

17. The Improved Method for Optimal Management of Worker and Business Data according to claim 1 further having the step of rolling across company data between sibling related corporations having income and expenditures according to one or more of the following criteria: Worker ID, Practice Group, Sub Practice Group, City ID, Region ID and National ID for the purposes of determining profitability.

18. The Improved Method for Optimal Management of Worker and Business Data according to claim 1 further having the step of prior to the transfer of work, informing the client of one or more of the following Worker Data at the second Work Office selected from the group comprising: a Resume, a Curriculum Vitae, a public review of a worker at the second Office, an in house review of a worker at the second Office, a list of worker licenses and a list of worker professional publications.

19. The Improved Method for Optimal Management of Worker and Business Data according to claim 5 further having the step of providing at least one worker with a work rating wherein when any worker at the second office has a work rating flagged by the System as being too low, the worker's name will be excluded from a Work transfer listing.

20. The Improved Method for Optimal Management of Worker and Business Data according to claim 1 further having the step of allowing a Worker in the first office to trigger a flag that the Worker is at under capacity for work and transmitting that flag to Management and other under utilized Company locations.
